(19) United States
(12) Patent Application Publication
(10) Pub. No.: US 2018/0219486 A1
(43) Pub. Date: Aug. 2, 2018

(54) ELECTRON ACCELERATOR GENERATOR

(71) Applicant: ARION TECNOLOGIA BRASIL - GESTÄO DE ATIVOS S/A, CEP-60150-161 Fortaleza CE (BR)

(72) Inventor: Gerson SILVA PAIVA, Rio de Janeiro (BR)

(73) Assignee: ARION TECNOLOGIA BRASIL - GESTÄO DE ATIVOS S/A, CEP-60150-161 Fortaleza CE (BR)

(21) Appl. No.: 15/538,153

(22) PCT Filed: Nov. 25, 2015
(86) PCT No.: PCT/BR2015/000175

§ 371 Date: Jun. 20, 2017

(30) Foreign Application Priority Data
Nov. 25, 2014 (BR) BR1020140294066

(51) Int. Cl. H02M 5/458; H02M 1/08

(52) U.S. Cl. CPC H02M 5/458; H02M 1/08

(57) ABSTRACT

The invention relates to an electron accelerator generator that comprises an electronic circuit powered by the electricity mains by means of a socket (1), two bridge rectifiers, a transformer (4), two electrolytic capacitors (7, 8), a bipolar transistor (9), a 110 V or 220 V Zener diode (10), a 11000 Ohm/10 W current limiting resistor for the Zener made of metal oxide or wire (11), a 600 Ohm/45 W wire resistor (12), a bank of six or more mega-capacitors connected in series of 20 to 1000 Farads/18 V each (13), an MOC 3012 photocoupler (14), two 4N25 photocouplers (15, 16), an LM 555 integrated circuit (17), a TIC 226 TRIAC or equivalent (18), an IGBT module for 1000 V/200 A or greater (19), a 330 Ohm/1 W metal-oxide resistor (20), a 220 Ohm/1 W metal-oxide resistor (21), a 3300 Ohm/1 W metal-oxide resistor (22), a 1000 Ohm/1 W metal-oxide resistor (23), a 1000 Ohm/1 W metal-oxide resistor (24), a 100 Ohm/1 W metal-oxide resistor (25) connected to the LM 555 integrated circuit (17), in which this circuit as a whole supplies any external load, the power of which is greater than the input power of the generator.

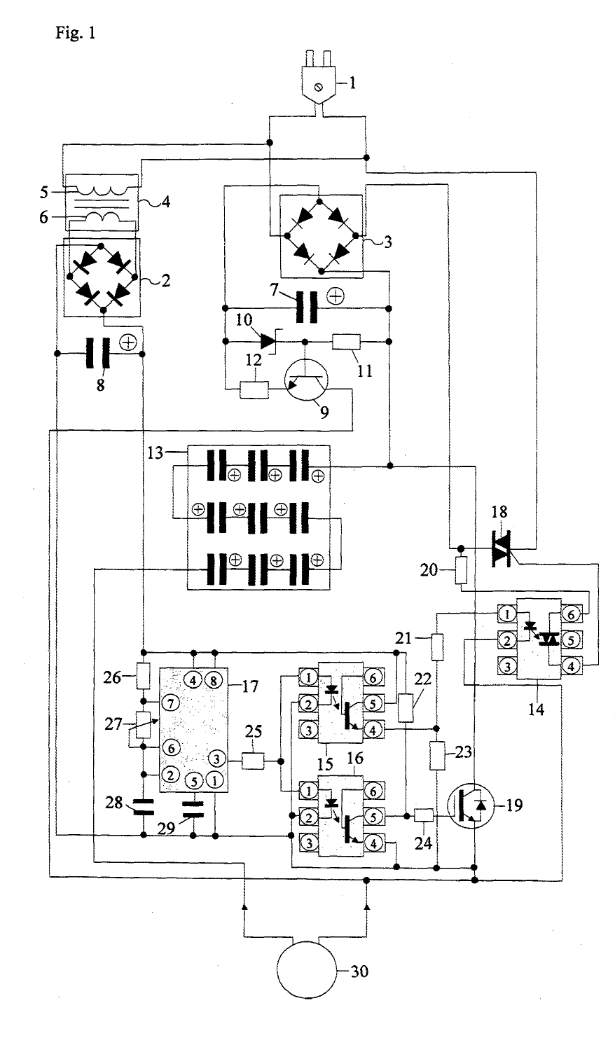

The present invention relates to an electron accelerator generator, and more particularly, to an electronic generator capable of producing high currents of monophase, biphase or triphase electrical energy at its outlet, starting from a small consumption of electrical current at its inlet in a monophase, biphase or triphase net (the number of phases being the same at the inlet and outlet), maintaining the inlet tension equal to the outlet tension. The present generator produces discharges of electrical energy impulses in any load (electrical motor, lamp, etc.) for domestic or industrial use. The present invention functions with alternate current, but not with direct current.

In a further aspect, the invention relates to an electron accelerator generator that comprises an electronic circuit powered by the electricity mains by means of a socket (1), two bridge rectifiers, a transformer (4), two electrolytic capacitors (7, 8), a bipolar transistor (9), a 110 V or 220 V Zener diode (10), a 11000 Ohm/10 W current limiting resistor for the Zener made of metal oxide or wire (11), a 600 Ohm/45 W wire resistor (12), a bank of six or more mega-capacitors connected in series of 20 to 1000 Farads/18 V each (13), an MOC 3012 photocoupler (14), two 4N25 photocouplers (15, 16), an LM 555 integrated circuit (17), a TIC 226 TRIAC or equivalent (18), an IGBT module for 1000 V/200 A or greater (19), a 330 Ohm/1 W metal-oxide resistor (20), a 220 Ohm/1 W metal-oxide resistor (21), a 3300 Ohm/1 W metal-oxide resistor (22), a 1000 Ohm/1 W metal-oxide resistor (23), a 1000 Ohm/1 W metal-oxide resistor (24), a 100 Ohm/1 W metal-oxide resistor (25) connected to the LM 555 integrated circuit (17), in which this circuit as a whole supplies any external load, the power of which is greater than the input power of the generator.

The known electronical converters for industrial use, named tension inverters or converters, are capable of activating operating monophase, biphase or triphase loads in monophase, biphase or triphase networks. However, such converters are incapable of producing high currents at their outlets, starting off from a small current at its inlet, while keeping the tension constant, i.e., keeping the inlet tension equal to the outlet tension of the generator, which makes them inefficient.

In view of this technical limitation, and with the purpose of overcoming it, the present generator, which is the object of this patent application, maintains the inlet tension approximately equal to the outlet tension, however amplifying the electrical current at the outlet, in this way making the generator very efficient in terms of energy production for monophase, biphase and triphase currents, which consume tenths, hundreds or even thousands of amperes, starting off from a small consumption of electrical current, in the amount of fractions of one ampere.

This constitutes a technological achievement already proved by us, which can be operated in the whole world as an energy source. The produced energy can be used for revolving monophase, biphase and triphase motors, with much larger potentials than the energy consumed by the generator, thanks to the acceleration effect of the electrons associated to N-P junctions (negative-positive) within the IGBT module, which composes the electronical circuit of the generator, as a result of successive energy discharges from the bank of mega-capacitors in the external load. “IGBT” means “Insulated Gate Bipolar Transistor”.

The attached drawing shows the arrangement of components of the present generator in their details.

In accordance with the attached drawing, the electron accelerator, there is an electronical circuit fed by the electrical network by means of a socket (1), two rectifying bridges of 1000V/20 A (2-3), each one comprising internally 4 rectifying diodes. A transformer (4) of 12 W with a ferro-silicium core with polarized grains, a primary coil of 110 or 220 V (5) and a secondary coil of 12V (6) is provided between the socket (1) and the rectifying bridge (2). The arrangement also includes two electrolytic capacitors of 1200 microfarads/400V (7-8), a bipolar transistor (9) of type MJ5024 or similar. Moreover, the arrangement comprises a Zener diode of 110V or 220V (depending on the tension of the load), per 5 W (10), a resistor which delimits the current of the Zener diode to 11000 Ohms/10 W made of metal oxide or wire (11), and a wire resistor of 600 Ohms/45 W (12). Also foreseen are banks including seven or more (depending on the tension at the network inlet) mega-capacitors (13) connected in series, each one of 20 to 1000 Farads/18V; one photo-coupler of the type MOC 3012 (14); two photo-couplers (also called opto-insulators) of the type 4N25 (15-16); one integrated circuit LM 555 (17); one triac of the type TIC 226 or equivalent, with a heat sink (18); an IGBT module for 1000 V/200 A or larger (19), also with a heat sink; a metal oxide resistor of 330 Ohms/1 W (20); a metal-oxide resistor of 220 Ohms/1 W (21); a metal-oxide resistor of 3300 Ohms/1 W (22); a metal-oxide resistor of 1000 Ohms/1 W (23); and a metal-oxide resistor of 1000 Ohms/1 W (24). A metal-oxide resistor of 100 Ohms/1 W (25) is connected to pin-3 of the integrated circuit LM 555 (17), and a metal-oxide resistor of 10000 Ohms/1 W (26) with one of the terminals connected to the pin-7, and the other one connected to pin-4 and pin-8 of the integrated circuit LM 555 (17). Moreover are provided a linear potentiometer of 100 000 Ohms (27) with a terminal connected to pin-2 and pin-6, and the other terminal connected to pin-7 of integrated circuit LM 555 (17); an electrolytic or ceramic capacitor of 100 to 20000 nanofarads (28) with one of its terminals connected to pin-2 and pin-6 of the integrated circuit LM 555 (17); a ceramic capacitor of 10 nanofarads (29) with one of the terminals connected to pin-5 of the integrated circuit LM 555 (17). This circuit or generator as a whole feeds any external load, be it an inductive load (such as a motor) or a resistive load (such as for instance incandescent lamps or heaters) (30), whose potency is larger than the inlet potency of the generator.

The wiring between the various components presented above is clearly indicated in the FIGURE.

### EXAMPLE 1

The arrangement according to the FIGURE was used to bring about an operation test of the invention. The feeding source of the arrangement was the domestic electrical network of 120 V and 60 Hz. The measured inlet current with a pliers ammeter was 0.6 A. At the outlet the tension was the same as at the inlet, namely 120 V and 60 Hz, while the outlet current was 43 A. Calculating the coefficient of performance (or the “COP”), we obtained the following result:

Pᵢₙ=120·0.6=72 W

Pₒᵤₜ=120·43=5160 W

COP=Pₒᵤₜ/Pᵢₙ=71

### EXAMPLE 2

The arrangement according to the FIGURE was used once again for realizing another operation test of the invention. Again the feeding source of the arrangement was the domestic electrical network of 120 V and 60 Hz. The measured inlet current with a pliers ammeter was 0.6 A. At the outlet the tension was the same as at the inlet, namely 120 V and 60 Hz, while the outlet current was 45 A. Calculating the coefficient of performance (or the “COP”), we obtained the following result:

Pᵢₙ=120·0.6=72 W

Pₒᵤₜ=120·45=5400 W

COP=Pₒᵤₜ/Pᵢₙ=75

The difference between Example 1 and Example 2 is due to fluctuations in the electron acceleration process between the bank of capacitors and the IGBT module.

Although the present invention has been described with a certain degree of particularity, the intention is that the invention comprise all modifications and alterations which would be compatible with the spirit and scope of the attached claims.

1. An electron accelerator generator, characterized in that it operates in a monophase, biphase or triphase network and generates a surplus of energy for use in monophase, biphase or triphase loads, such as monophase, biphase or triphase electrical motors, or resistive loads, such as heaters, greenhouses or incandescent lamps, and whose operation principle is due to the increase of the electrical current by means of an acceleration of the electrons in the N-P junction of a IGBT module (“Insulated Gate Bipolar Transistor”) (19) which composes the electronical circuit of the generator, as a consequence of successive energy discharges of a bank of mega-capacitors (13) on the external load.

2. An electron accelerator generator according to claim 1, characterized in that it uses the energy from an already existing monophase, biphase or triphase network (30) for the production of a surplus of monophase, biphase or triphase electrical current by an increase of the electrical current applied at its inlet, which increase is due to an impulse of electrical energy during the discharge of a bank of loaded capacitors at the N-P junction of the IGBT by a constant current source, of low consumption of electrical energy, generating an intense current at the outlet of the generator when this bank of capacitors is discharged over external loads by the intermediation of an IGBT module (19).
